(19) United States
(12) Patent Application Publication
(10) Pub. No.: US 2010/0257270 A1
(43) Pub. Date: Oct. 7, 2010

(54) Internet Background Advertisement Changeable Broadcasting System

(75) Inventor: Yung-Chang HSU, TAICHUNG CITY (TW)

Correspondence Address: BRIAN M. MCINNIS, 12th Floor, Ruttonjee House, 11 Duddell Street, Hong Kong, HK

(73) Assignee: QUALITY ART TECHNOLOGY CO., TAICHUNG CITY (TW)

(21) Appl. No.: 12/686,382

(22) Filed: Jan. 13, 2010

(30) Foreign Application Priority Data
Apr. 2, 2009 (TW) 98111041

(51) Int. Cl. G06F 15/173

(52) U.S. Cl. 709/226

(57) ABSTRACT

An Internet background advertisement changeable broadcasting system is disclosed. The system includes a serving terminal and many advertising terminals. Each of the advertising terminals provides various kinds of services to a user terminal. Each of the advertising terminals connects the serving terminal to obtain at least one background advertisement. Once the user terminal refreshes the web page of the advertising terminal via an browser, the advertising terminal requests the serving terminal to provide a new background advertisement via the Cascading Style Sheets.

### RELATED APPLICATIONS

This application claims priority to Taiwan Patent Application Number 98111041, filed Apr. 2, 2009, which is herein incorporated by reference.

### BACKGROUND

1. Technical Field

The present invention relates to the Internet advertisement. More particularly, the present invention relates to the background advertisement on the Internet.

2. Description of Related Art

As the growing of the Internet industry, the Internet advertisement has replaced the print advertisement. Since the space of a web page is finite, the background of the web page becomes the most important resource due to its largest space. At least two drawbacks limit the development of the Internet advertisement. First, the advertising effectiveness of the Internet advertisement is hard to measure. Second, the background space of the web page is also finite and hard to satisfy the requirement of the advertisers.

### SUMMARY

According to one embodiment of the invention, an Internet background advertisement changeable broadcasting system is disclosed. The system includes a serving terminal and at least one advertising terminal. The advertising terminal signally connects to the server terminal, and the advertising terminal is applied to be accessed by at least one browser. The advertising terminal requests a background advertisement from the server terminal via a cascading style sheet, and further provides the background advertisement to the browser.

### BRIEF DESCRIPTION OF THE DRAWINGS

The invention can be more fully understood by reading the following detailed description of the embodiment, with reference made to the accompanying drawings as follows:

FIG. 1 is a schematic view of the Internet background advertisement changeable broadcasting system of one embodiment of the invention.

FIG. 2 is a schematic view of the web page 210 of FIG. 1, illustrating the identification information 212 being merged in the background advertisement 211.

FIG. 3 is a schematic view of FIG. 1, illustrating the server terminal 110 obtains a cookie 400 from the user terminal 300 via the advertising terminal 200.

FIG. 4 is a flow chart of FIG. 1, illustrating the server terminal 110 broadcasts background advertisements 211 in sequence to the user terminal 300 via the advertising terminal 200, and the advertising effectiveness of the background advertisements 211 are recorded and reported.

### DETAILED DESCRIPTION

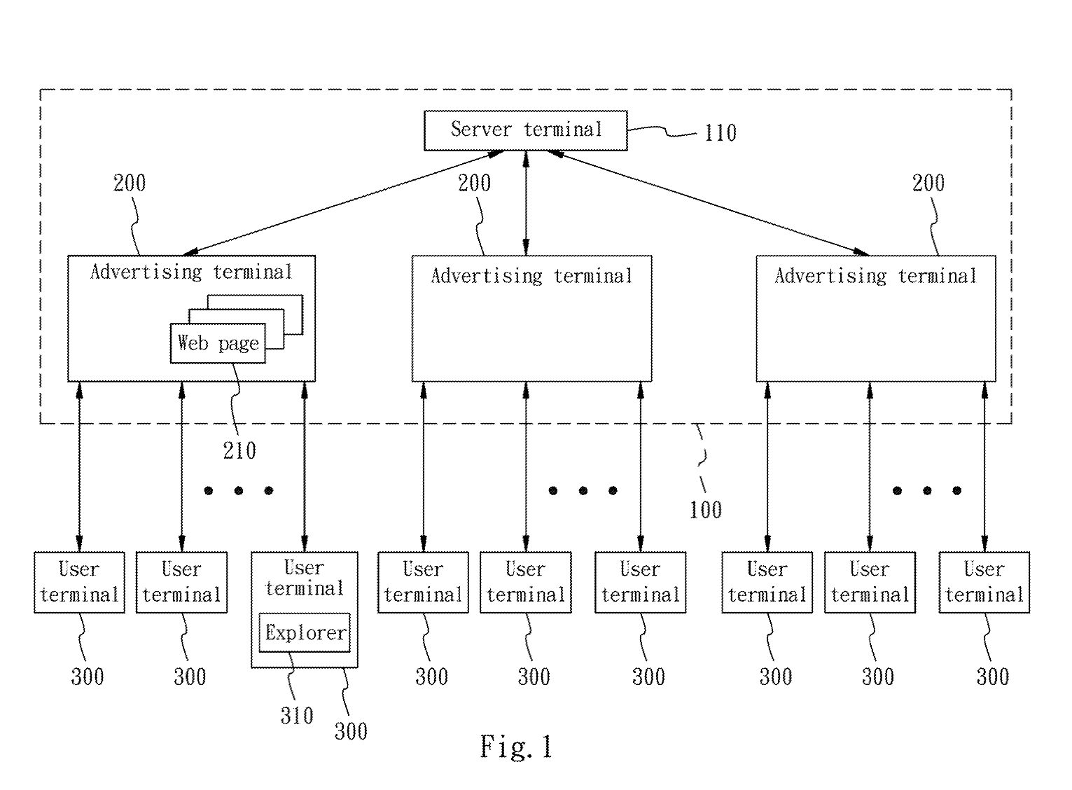

Refer to FIG. 1. FIG. 1 is a schematic view of the Internet background advertisement changeable broadcasting system of one embodiment of the invention. In FIG. 1, the Internet background advertisement changeable broadcasting system 100 includes a server terminal 110 and many advertising terminals 200. Each of the advertising terminals 200 is applied to provide variety kinds of services to many user terminals 300. In detail, the advertising terminal 200 is a website such as a portal or a blog. The advertising terminal 200 provides many hyperlinks to the user terminal 300. In other words, each advertising terminal 200 is signally connected to the server terminal 300, and each user terminal 300 is signally connected to the advertising terminal 200 via an browser 310.

Wherein, a daemon program is installed in the cascading style sheet, CSS, of the advertising terminal 200. The daemon program obtains at least one background advertisement from the server terminal 110. Therefore, once the browser 310, such as an internet explorer, accesses the advertising terminal 200, the advertising terminal 200 requests a new background advertisement from the server terminal 110 via the CSS, and the advertising terminal 200 provides the new background advertisement to the user terminal 300. In other words, every time when the browser 310 refreshes the content of the web page of the advertising terminal 200, the advertising terminal 200 also refreshes the background advertisement. Therefore, the embodiment uses the finite resource of the web page to provide variety kinds of background advertisements.

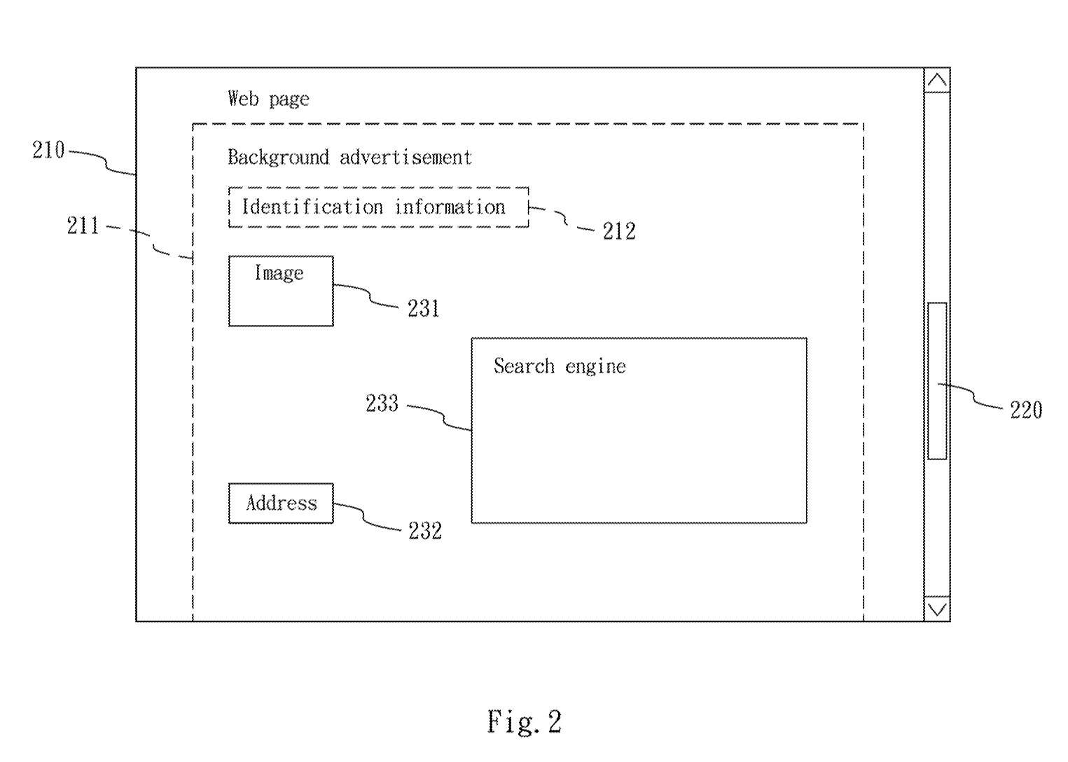

Refer to FIG. 2. FIG. 2 is a schematic view of the web page 210 of FIG. 1, illustrating the identification information 212 being merged in the background advertisement 211. In FIG. 2, the web page 210 usually contains many objects, such as the image 231, the virtual address 232 and the search engine 233. Meanwhile, the web page 210 usually has many non-background advertising frames on it. However, the advertising frames may be shadowed as the roller 220 is moved, the advertising effectiveness of the advertising frames is far behind the background advertisement 211.

Generally speaking, it is hard to measure the advertising effectiveness of the web advertisement. For instance, two web sites broadcasting the same advertisement are hard to be distinguished as which one affects the audiences more. Therefore, the embodiment further provides an identification information 212, such as a code, generated by the server terminal 110 to overcome the drawback described above. The identification information 212 carries information that relates to the theme of the background advertisement 211. For instance, the identification information 212 carries information relating to the trade articles of the background advertisement 211, such as the serial number of a good or the phone number of the seller. Therefore, when the user is influenced by the background advertisement 211 and purchases the trade article, the user may report the serial number of the goods or call a particular phone number. And then, the advertising effectiveness of the background advertisement 211 can be recorded.

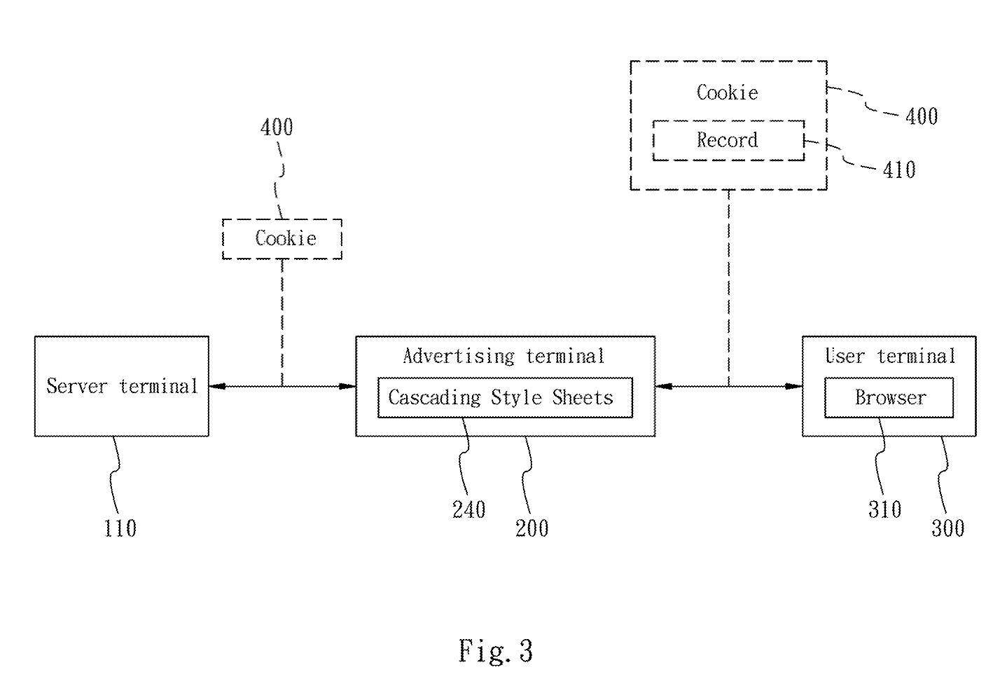

Refer to FIG. 3. FIG. 3 is a schematic view of FIG. 1, illustrating the server terminal 110 obtains a cookie 400 from the user terminal 300 via the advertising terminal 200. The embodiment further provides a mechanism to prevent the auto click program that automatically triggers the hyperlinks of the web page 210 and thus establishing a false appearance that the background advertisement 211 of a particular advertising terminal 200 is well broadcasted. The mechanism is that the server terminal 110 requests the cookies 400 from the advertising terminal 200, and the advertising terminal 200 requests the cookies 400 from the browser 310 of the user terminal 300.

Since the cookie 400 records a web information only when the browser 310 completely reads the web page 210 and the background advertisement 211, the embodiment collects the cookie 400 to make sure the browser 310 of the user terminal 300 has read the web page 210 and the background advertisement 211 but not merely triggering the hyperlinks of the web page 210 by the auto click program.

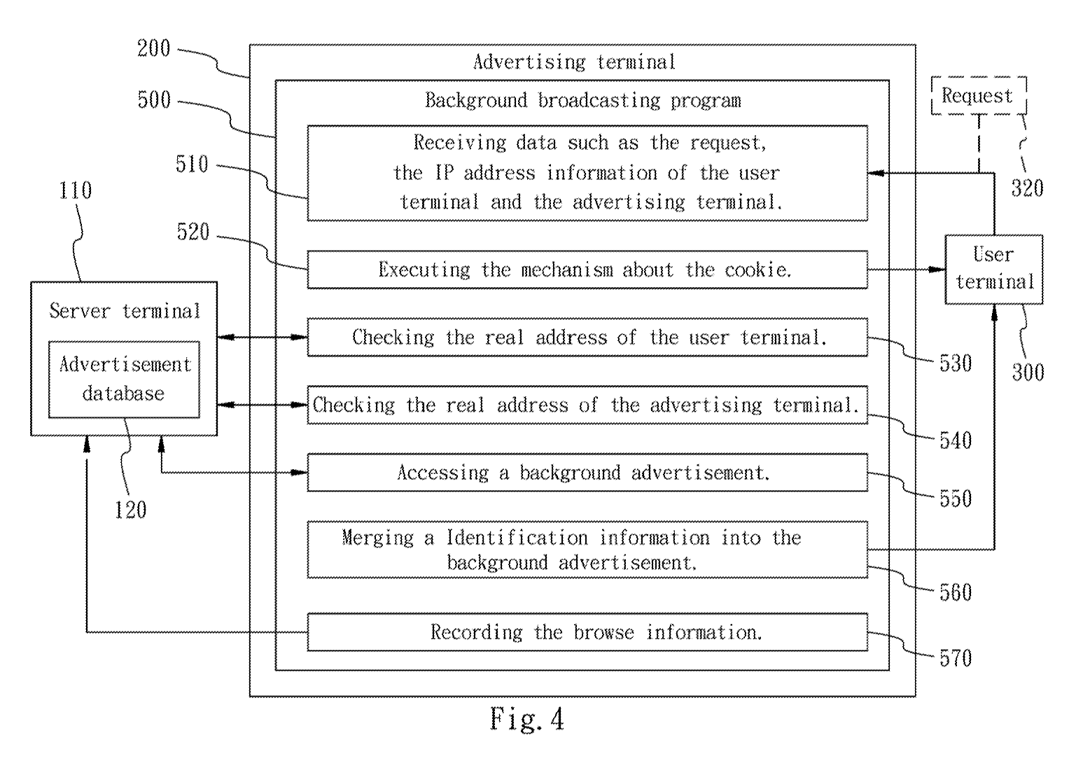

Refer to FIG. 4. FIG. 4 is a flow chart of FIG. 1, illustrating the server terminal 110 broadcasts background advertisements 211 in sequence to the user terminal 300 via the advertising terminal 200, and the advertising effectiveness of the background advertisements 211 are recorded and reported. In detail, a daemon program is inserted in the CSS of the advertising terminal 200, such as a background broadcasting program 500. The background is broadcasting program 500 obtains variety kinds for background advertisements 211 from the advertisement database 120 of the server terminal 110, and further display them to the user terminal 300. The information of the user terminal 300, such as the cookies 400 and the IP address, are collected via the background broadcasting program 500 to measure the advertising effectiveness.

The functions and steps of the background broadcasting program 500 are illustrated as following:

First, as shown in step 510, the background broadcasting program 500 receives a request 320 from the user terminal 300, and further records many data, such as the request 320, the IP address information of the user terminal 300 and the IP address information of the advertising terminal 200.

Second, as shown in step 520, the background broadcasting program 500 executes the mechanism mentioned above to obtain the cookie 400 from the user terminal 300. In other words, the background broadcasting program 500 uses the cookie 400 to prevent the auto click program.

Third, as shown in step 530, the background broadcasting program 500 further checks the real address of the user terminal 300 via the IP address of the user terminal 300. In other words, the server terminal 110 checks whether the customer of the user terminal 300 has the ability to purchase the theme of the background advertisement 211. For instance, one good may only be sold in a particular country. Therefore, the user terminal 300 located in other countries should not have to receive the related background advertisement 211.

At the same time, as shown in step 540, the background broadcasting program 500 further checks the advertising terminal 200 via the IP address of the advertising terminal 200. In detail, the server terminal 110 checks the IP address of the advertising terminal 200 to make sure the advertising terminal 200 is really authorized by the sponsor of the server terminal 110. In other words, the server terminal 110 checks the IP address of the advertising terminal 200 to exam whether the CSS is moved to another web site that didn't belong to the vendor of the sponsor.

Fourth, as shown in step 550, the background broadcasting program 500 accesses a background advertisement 211 from the server terminal 110. The functions of the background broadcasting program 500 include: checking whether the storage array of the advertising terminal 200 is an empty array, matching a particular background advertisement 211 to a particular advertising terminal 200, accessing the background advertisement 211 to the storage array, reading the storage array in sequence, and calculating the exposure times of the background advertisement 211.

To improve the broadcasting efficiency, the advertising terminal 200 can obtain many background advertisements and stores them in the storage array of itself. Therefore, the background broadcasting program 500 checks whether the storage array of the advertising terminal 200 is empty or not, and provides a figure, i.e. the background advertisement 211, to the advertising terminal 200 in high priority when it is empty.

The background broadcasting program 500 also can match a particular background advertisement 211 to a particular advertising terminal 200. For instance, goods related to sports is matched to the blog discussing baseball or something similar, and the background advertisement 211 relating cosmetics is matched to the web page about lady's talk.

The background broadcasting program 500 accesses the suitable background advertisements 211 to the storage array of the advertising terminal 200 for being broadcasted. The background broadcasting program 500 further counts the exposure times of each background advertisements 211.

What is worth discussing is that the background broadcasting program 500 arranges the sequence of the background advertisements 211 in accordance with their own exposure times. In other words, the background broadcasting program 500 arranges the sequence of the background advertisements 211 in the storage array to average the exposure times of the background advertisements 211.

In step 530, the server terminal 110 not only checks the real address of the user terminal 300 via its IP address, but also detects the language being used in the request 320 to determine which country the user terminal 300 is located.

Meanwhile, in step 540, the server terminal 110 not only can use the IP address of the user terminal 300 to check the real address of the user terminal 300, but also can use the matching function to detect the information, such as the language family, to check the real address.

Fifth, as shown in step 560, the background broadcasting program 500 merges an identification information 212 into the background advertisement 211. In detail, the background broadcasting program 500 checks whether an identification information 212 is suitable to be merged in a background advertisement 211 or not. The background broadcasting program 500 generates an identification information 212 and merges the identification information 212 with the background advertisement 211 when it is suitable. And then the background broadcasting program 500 broadcasts the background advertisement 211 which is merged with the identification information 212. The identification information 212 can be provided by the server terminal 110 or generated by the advertising terminal 200 and further reported to the server terminal 110.

Finally, as shown in step 570, the background broadcasting program 500 records the browse information, such as the exposure times of the background advertisement 211. The background broadcasting program 500 reports the information to the server terminal 110. A skilled one can edit the background broadcasting program 500 based on the functions described by the embodiment via a computer program, such as the JAVA or the C language. A skilled one also can use the JAVASCRIPT to control the CSS directly or indirectly.

What is claimed is:

1. An Internet background advertisement changeable broadcasting system comprising:
a server terminal; and
at least one advertising terminal signally connected to the server terminal, and applied to be read by at least one browser;
wherein, the advertising terminal requests a background advertisement from the server terminal via a cascading style sheet, and provides the background advertisement to the browser.

2. The Internet background advertisement changeable broadcasting system of claim 1, wherein the server terminal generates an identification information, and merges the identification information into the background advertisement when the background advertisement is provided to the browser via the advertising terminal.

3. The Internet background advertisement changeable broadcasting system of claim 1, wherein the advertising terminal generates an identification information, and merges the identification information into the background advertisement when the background advertisement is provided to the browser.

4. The Internet background advertisement changeable broadcasting system of claim 1, wherein the browser writes a record into a cookie when the background advertisement is read by the browser.

5. The Internet background advertisement changeable broadcasting system of claim 4, wherein the server terminal receives the cookie via the advertising terminal.

6. The Internet background advertisement changeable broadcasting system of claim 1, wherein the cascading style sheets further comprises a background broadcasting program.

7. The Internet background advertisement changeable broadcasting system of claim 6, wherein the background broadcasting program provides a physical internet protocol address of the browser to the server terminal.

8. The Internet background advertisement changeable broadcasting system of claim 6, wherein the background broadcasting program provides a virtual internet protocol address of the browser to the server terminal.

9. The Internet background advertisement changeable broadcasting system of claim 6, wherein the background broadcasting program arranges a broadcasting sequence for the background advertisement.

10. The Internet background advertisement changeable broadcasting system of claim 6, wherein the background broadcasting program calculates an impression number of the background advertisement.

11. The Internet background advertisement changeable broadcasting system of claim 10, wherein the background broadcasting program reports the impression number to the server terminal.

12. The Internet background advertisement changeable broadcasting system of claim 6, wherein the background broadcasting program matches the background advertisement with the advertising terminal.
